(19) United States
(12) Patent Application Publication
(10) Pub. No.: US 2006/0146385 A1
(43) Pub. Date: Jul. 6, 2006

(54) Visual effect based on a micro-optical grid structure

(75) Inventors: Pertti Paakkonen, Joensuu (FI); Pasi Laakkonen, Joensuu (FI)

Correspondence Address: VENABLE LLP, P.O. BOX 34385, WASHINGTON, DC, 20045-9998, US

(73) Assignee: Avantone OY, Tampere (FI)

(21) Appl. No.: 10/539,993

(22) PCT Filed: Dec. 22, 2003
(86) PCT No.: PCT/FI03/00979

§ 371 Date: Feb. 9, 2006

(30) Foreign Application Priority Data
Dec. 23, 2002 (FI) 20022268

(51) Int. Cl. G02B 5/32

(52) U.S. Cl. 359/15

(57) ABSTRACT

A micro-optical grid structure formed on a substrate, a method for producing the grid structure, and a product that includes one or several pattern areas formed by the grid structure. The grid structure is arranged to produce for a viewer a holographic or corresponding visual effect based on the diffraction of light by directing the light diffracted from the grid structure and corresponding to the design wavelength substantially to only a few diffraction orders. Single diffraction order thus corresponds to a certain observing direction of the visual effect observed on said design wavelength. The grid structure is arranged to leave a free range of angles between adjacent observing directions, such that the grid structure being examined from directions corresponding to the range of angles does not produce for the viewer a clearly observable effect based on diffraction, the grid structure is thus substantially transparent.

The invention relates to a micro-optical grid structure formed on a substrate. The invention also relates to a method for producing a micro-optical grid structure of the above-mentioned kind. The invention also relates to a product comprising one or several micro-optical grid structures of the above kind.

### BACKGROUND OF THE INVENTION

Holograms and corresponding diffractive elements based on the interference of light are currently used quite widely for various purposes. Typical uses of holograms include for example prevention of counterfeits (for example identification cards, means of payment, audio recordings, software products), enhancing the attractiveness of the product in markets of strong competition as well as emphasizing the especially high quality, “high tech” or pioneering nature of the product,

There are various known manufacturing techniques for the holograms suitable for these purposes.

Conventional manufacturing techniques for holograms are based on the use of different exposure methods. In these methods the diffractive volumetric grid required for the hologram is transferred on a photo-sensitive substrate exposure and without mechanical shaping of the substrate. Photosensitive substrate materials suitable for the purpose include for example photopolymers, dichromate gelatins, and silver halides. The hologram manufactured in this way can be transferred further to the desired target by attaching the substrate containing the hologram on the surface of the target, for example on the surface of a product package.

Holograms can also be manufactured by so-called embossing. In techniques based on embossing, the hologram pattern copied as a surface pattern in the printing means is transferred mechanically by pressing it as a surface grid on the substrate. In this case the substrate is typically a metal film or a metallized film, for example an aluminized/aluminium film. In these applications it is an important task of the metal/metallized film to function as a substrate as well as to improve the reflection of light from the hologram, thus promoting the discernibility of the visual effect. Typically also holograms manufactured by means of embossing are manufactured separately on a suitable substrate, for example on aluminized film, and transferred only thereafter to the final target by fastening said substrate containing the hologram on the surface of the target.

In many applications of holograms or corresponding visual diffractive effects, it would be highly desirable that the visual effect attained by means of the same would be both easily discernible but at the same time also at least somewhat “transparent”. This would make it possible to examine the text and images under the effect for example in an identification card, or to examine the product itself when the effect is used in various product packages.

When the transparency of the visual effect is considered in the above-mentioned purpose, one should separate the concepts of the transparency of the substrate carrying the hologram (for example an opaque metal film versus a transparent substrate), as well as the “transparency” of the visual effect itself, generated by the hologram acting as a volumetric or surface grid on said surface. The latter transparency thus refers to the way in which the visual effect produced by the hologram disturbingly “covers” with its brightness the marking or pattern located on the substrate or behind the substrate. In the following, these two concepts will be separated from each other by referring to the former concept as the transparency of the substrate material and to latter concept as the transparency of the visual effect implemented on a substrate.

U.S. Pat. No. 5,142,384 discloses a solution which to a some extent aims at satisfying the above-presented needs for the part of the transparency of the substrate material as well as the transparency of the visual effect implemented thereon. According to the teachings of said publication a so-called Lippman-Bragg-type reflection hologram based on the use of a volumetric grid can be manufactured on a transparent film by means of exposure technique (silver halide as a photosensitive substance), and said film can be further arranged as a window in a product package. According to the publication, the Lippman-Bragg hologram is characterized in that it can be clearly discerned only at a viewing angle of ±20° in relation to the intended viewing direction of the hologram, said viewing direction being typically perpendicular to the surface of the substrate. Outside said viewing angle the hologram is not clearly discernible, wherein the text or product under the hologram, in turn, can be better discovered. When a product package intended for consumers and equipped with a Lippmann-Bragg hologram is positioned for example on a shelf in a store, the hologram flashes into view in a certain viewing angle, and catches the attention of the consumer.

U.S. Pat. No. 5,128,779 discloses a solution in which the partial transparency of the reflection hologram is based on the fact that the at least to a some extent transparent material used as a substrate of the hologram is only here and there covered with a reflective film. In the sections where the reflective film is missing, said substrate is transparent at least to a certain degree. The transparency of the effect itself does not become evident in the publication.

U.S. Pat. No. 5,585,144 discloses a reflection hologram in which characters or images produced with printing ink are combined with the micro-optical surface of a hologram produced by means of embossing. The structure also comprises a reflective film, on top of which both the hologram effect and the characters/images produced with printing ink are visible. Due to the use of the reflective film, the structure is not transparent as a whole, and thus not suitable for example to be used in the window of a product package.

All the above-described solutions of prior art, by means of which it is possible to attain in some way transparent holographic effects can, however, be considered unsatisfactory especially in such embodiments in which the aim is to produce holographic effects by mass production for example for various packaging materials or printed products. There are also considerable limitations in solutions of prior art with respect to the ability of implementing the visual effects in desired colours to be visible in the desired direction. The last mentioned aspect is significant for example when the aim is to represent the colours of various logos or trademarks in their original hue in the holograms.

Various solutions based on the exposure technique and volumetric grids produced on a substrate by means of said technique (for example U.S. Pat. No. 5,142,384) are not well suited for mass production, and due to the production method therein, it is necessary to set considerable special requirements for the substrate and its materials (photosensitive chemical compounds). As to the substrate, very good transparency of the substrate is not necessarily attained either in these solutions, because the volumetric grids always require a certain minimum thickness of the substrate in addition to the fact that a photosensitive material suitable for the purpose must be used as the substrate. The Lippman-Bragg hologram based on a volumetric grid that is disclosed in the U.S. Pat. No. 5,142,384 also exhibits significant limitations related to the viewing angle, said limitations preventing the implementation of the visual effect so that it is visible to a specific desired direction. Furthermore, the brightness of Lippman-Bragg holograms is typically rather modest.

In holograms of prior art produced by means of embossing, the discernibility of the holograms must be typically improved in practice by means of a light-reflecting layer arranged in the substrate or in connection with the same, which, of course, restricts the transparency of the effects/substrate and narrows down the selection of the materials that are suitable as substrates. Without the use of reflective layers, the solutions of prior art that are based on surface grids produce effects of rather modest brightness.

Short Description of the Invention and its Primary Advantages

It is an object of the present invention to disclose a solution of a new type for producing a hologram or a hologram-like visual effect based on the diffraction of light. It is a special purpose of the invention to introduce a solution that is suitable for producing substantially transparent, but at the same time in certain conditions very bright and thus easily discernible visual effects on a substrate, said substrate itself being preferably transparent. By means of the invention it is also possible to produce transparent visual effects on non-transparent substrates. The embodiment according to the invention does not necessarily require the use of special reflective metal layers or the like on the substrate to improve the discernibility of the effect.

In practice, the invention solves the problem appearing in holograms of prior art as a certain kind of contradiction between the good discernibility (brightness) of the hologram and the transparency of the visual effect.

By means of the invention, in its preferred embodiment, it is possible to produce for example on a bright, substantially completely transparent plastic film a visual diffractive effect that is discernible only from a certain direction, the plastic film and the effect carried by the same being substantially transparent when examined from the other directions. Such a plastic film can be used for example as a packaging material through which the product packed therein can be examined.

On the other hand, by means of the invention it is possible to produce a transparent visual diffractive effect on paper or paperboard non-transparent as such, said effect making it possible to discern a text or patterns printed on said material from certain directions without being disturbed by the visual effect. The substrates themselves can also be materials that filter and/or reflect light in different ways, i.e. in practice they are coloured materials.

By means of the invention it is possible to implement a visual diffractive effect so that it is visible in the desired colour to a certain direction. This is especially important for example when the object is to reproduce certain product colours or characterizing colours.

To attain these purposes, the micro-optical grid structure according to the invention producing a visual diffractive effect, is primarily characterized in what will be presented in the characterizing part of the appended independent claim 1.

The method according to the invention for implementing a micro-optical grid structure producing a visual diffractive effect, in turn, is primarily characterized in what will be presented in the characterizing part of the appended independent claim 9.

The product containing a micro-optical grid structure according to the invention is, in turn, primarily characterized in what will be presented in the characterizing part of the appended independent claim 17.

The other, dependent claims will present some preferred embodiments of the invention.

The present invention is essentially based on the idea that a micro-optical diffractive grid structure, preferably a surface grid structure, is produced on a substrate, said grid structure being arranged to direct the visual effect (hologram) it reflects on a very limited number of different diffraction orders. One central factor in reducing the number of the diffraction orders is the selection of a sufficiently small value for the grid period.

Preferably, the visual effect is reflected substantially only in one, or few diffraction orders at the most, said diffraction orders corresponding to the different observing directions of the visual effect. Hereinbelow in this application the term observing direction refers to such a viewing direction from which the visual effect according to the invention can be discerned. When examined outside the observing direction or from the range of angles between the observing directions, the visual effect according to the invention is substantially “transparent”.

Because there is a significantly larger number of observing directions in solutions of prior art when compared to the invention (for example >10), there does not remain such ranges of angles between these observing directions in which the effect would be transparent in the way referred to in this application. Thus, it can be said that the basic idea of the invention is that, firstly, the number of observing directions is restricted in the invention, and secondly, in the case of more than one observing directions, they are implemented in such a manner that a sufficiently large free range of areas remains between the observing directions, in which the effect is transparent. In addition, the invention provides the possibility to affect the relative brightness of different observing directions, said brightness being determined by the diffraction efficiencies of the diffraction orders corresponding to the different observing directions.

Because the light reflected by the grid structure is now directed so that it is reflected only to a few observing directions, the visual effect can be observed in these directions as a bright one. In the observing directions other than the above-mentioned ones the grid structure according to the invention does not produce a significant diffractive effect, i.e. it does not reflect light diffractively, wherein the surface of the substrate, despite of a slight diffuse reflection, thus appears to the viewer to be similar to a surface completely without said grid structure. Thus, in these other viewing directions the diffractive effect itself is substantially transparent, thus making it possible to discern the printing or other markings on the substrate without being disturbed by the effect.

When the substrate material is transparent, the invention enables a good visibility through the substrate to the target behind it in other viewing directions deviating from the observing directions.

When the reflection of light is directed to only one or a few narrow ranges of areas, i.e. observing directions, the effect is discerned brightly in these directions. Thus, in the solutions according to the invention, it is also possible to utilize as a substrate a transparent material that does not substantially reflect light itself. In holograms of prior art, the light reflected from the grid structure is distributed over several orders, which impairs the brightness of the individual orders. Thus, in solutions of prior art, the reflectance of the substrate must often be improved for example by using aluminium films. This, of course, eliminates the possibility to implement entirely transparent structures.

In a preferred embodiment of the invention the properties of the grid structure are arranged such that the light diffracted from the grid structure is directed to −1 diffraction order, in which it is possible to attain good diffraction efficiency.

In a preferred embodiment of the invention the grid structure is preferably formed as a surface grid structure on the substrate, and the manufacture takes place preferably by means of embossing. The invention is not, however, restricted solely to pure surface grid structures, but the grid structure according to the invention can also be protected with a suitable protective layer, such as a structure protected with a lacquer layer, for example. The grid structure according to the invention can also be implemented as various partially or entirely buried grid structures that can be manufactured for example by laminating.

As the substrate of the grid structure of the invention, a substantially transparent, clear plastic-like material is preferably used. Thus, by means of the solution according to the invention a substantially transparent film that can be used for example as a packaging material is attained both for the substrate and for the visual effect. In viewing directions other than the observing directions such a packaging material, for example a plastic film, is thus transparent, making it possible to examine the product packed therein through the film. The holograms on the film flash brightly into view in observing directions characteristic for them, thus catching the attention of a consumer, for example.

It is also possible to use for example paper or paperboard as substrate material, wherein effects according to the invention can be implemented in different printed products. Furthermore, suitable materials for the substrate include also various metal or metallized films, which reflect light and enhance the holographic effect.

By means of the diffractive grid structures according to the invention it is possible to produce on the substrate one or several pattern areas producing a visual effect, and said pattern areas can cover the area of the substrate either partially or completely. Single pattern area can represent for example an image, a letter, a character, a background pattern or another visual effect. By means of several pattern areas it is thus possible to implement for example texts or images.

A single pattern area can also be used alone to cover substantially the entire available surface area of the substrate.

Different pattern areas can be implemented in such a manner that they all share the same observing direction, or so that there are different observing directions between the different pattern areas. The pattern areas can also be implemented in such a manner that they can be detected from different sides of the film-like or planar substrate.

A single pattern area is implemented in such a manner that a selected “design wavelength” is reflected to the observing direction characteristic for the pattern area, i.e. the effect is observed from said observing direction in the desired colour. In the narrow range of angles surrounding this observing direction it is possible to see the effect as a spectrum formed around said design wavelength.

Two pattern areas can have the same observing direction, but when examined from said observing direction, said pattern areas are discerned in colours differing from each other, i.e. different design wave-length areas may have been selected for them.

The pattern area or areas according to the invention can be produced on a substrate that is transferred to the final target by attaching said substrate containing the visual effect/effects on the surface of the final target for example as an adhesive label. Preferably, the pattern area or areas according to the invention are, however, produced directly on the final target, for example on a plastic film functioning as a packaging material or on the paper of a printed product. In mass production this is preferably implemented by means of embossing technique.

### BRIEF DESCRIPTION OF THE DRAWINGS

The invention and its fundamental properties as well as the advantages to be attained by means of the invention will become more evident for the person skilled in the art from the following description in which the invention will be described in more detail by means of a few selected examples, at the same time referring to the appended drawings, in which

FIG. 1 shows in principle the definitions of the most important grid parameters as well as a first alternative of beam distribution with two actual diffracted orders,

FIG. 2 shows in principle in a way similar to FIG. 1 a second alternative of beam distribution in which four actual diffracted orders occur,

FIG. 3 shows in principle in a way similar to FIG. 1 a third alternative of beam distribution in which only one actual diffracted order occurs in accordance with a preferred embodiment of the invention,

FIG. 4 shows by way of example pattern areas formed on the substrate, their observing directions as well as design wave-lengths,

FIG. 5 shows by way of example pattern areas formed on the substrate in a case in which the observing directions of the pattern areas are designed to deviate from each other,

FIG. 6 shows an alternative, substantially triangular grid profile,

FIG. 7 shows an alternative, substantially sinusoidal grid profile,

FIG. 8 shows an alternative, substantially blazed-type grid profile,

FIG. 9 illustrates a way of displaying products containing a visual effect according to the invention, and

FIG. 10 illustrates a product package containing a visual effect according to the invention.

### DETAILED DESCRIPTION OF THE INVENTION

In the following, the invention will be described in more detail by using as an example primarily embodiments that are based on a surface grid structure.

At first, such properties of the diffractive grid structure according to the invention will be discussed by means of which the “transparency” of the visual effect produced by the grid structure is attained by directing the reflection of light to a few, preferably substantially to only one diffraction order/observing direction. Furthermore, it will be presented how the relative brightness of different observing directions can be influenced by affecting the efficiency of the diffraction orders.

Thereafter the properties of pattern areas produced by means of the invention as well as their use in producing visual effects will be discussed.

Furthermore, examples of substrate materials on which grid structures according to the invention can be implemented will be presented along with examples of some alternative grid profile types.

Finally, examples of the use of visual effects implemented by means of the invention in various products will be presented.

Grid Structure

Typically the starting point in producing a visual diffractive element according to the invention is a periodic diffraction grid G that distributes the light impinging on the grid in parts reflected in different directions in accordance with a grid equation (1) known as such.
sin(α)=sin(β)−m*λ/d (1)
in which α is the incidence angle of light,
β is the angle of departure i.e. diffraction angle of light,
m is the diffraction order (integer),
λ is the wavelength of light, and
d is the grid period

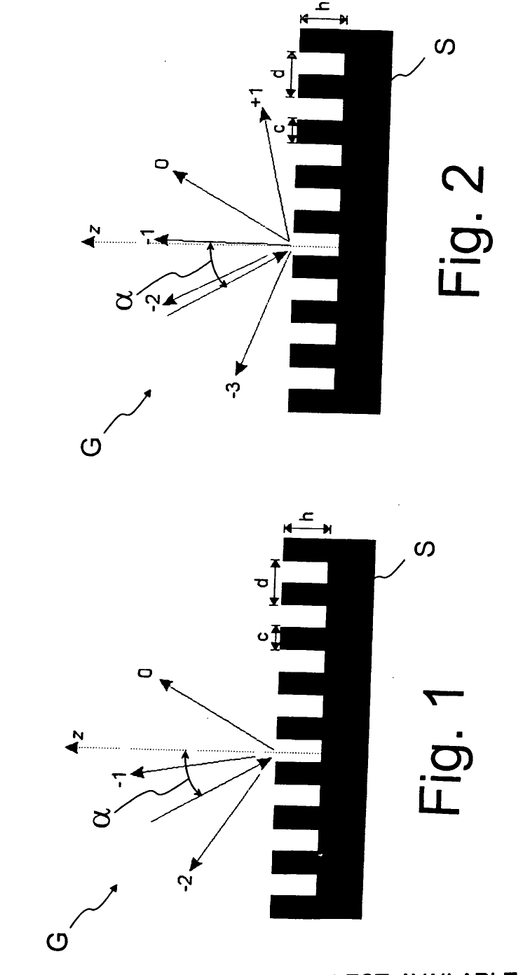

FIGS. 1 to 3 present the definitions of the most important grid parameters d,h,c of a grid structure G formed on a substrate S in the case of a so-called binary surface grid, and illustrate three different beam distribution alternatives when light with the wavelength λ impinges upon the surface grid G located on the transparent plastic substrate S.

The above-mentioned grid parameters are: grid period d, grid depth h, and width c of the grid profile. The width c of the grid profile can also be indicated as the so-called filling factor of the grid, i.e. the length of the grid line in relation to the grid period d.

In the situations of FIGS. 1 and 2 the incidence angle a of light in relation to the normal z of the surface of the grid is −30° and in the situation of

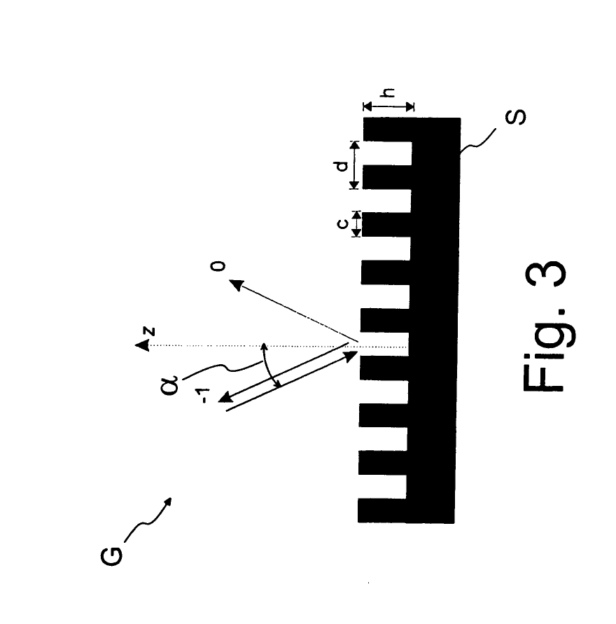

FIG. 3 the incidence angle a corresponds to the so-called Bragg's incidence angle. These angles, as well as the diffraction angles β of the beams reflected from the surface and corresponding to the various diffraction orders m are determined in relation to the normal z of the surface so that the angles on the right-hand side of the normal z of the surface exhibit positive angle values and the diffraction angles on the left-hand side exhibit negative angle values, respectively.

In the situation of FIG. 1, the selection of the grid parameters is made in such a manner that the ratio d/λ=1.5, in FIG. 2 the ratio d/λ=2.1 and in the case of FIG. 3 d/λ=1.2 It should be noticed that because FIGS. 1 to 3 are drawn only in principle, the change of the grid period d is not drawn therein by drawing means.

By inserting the aforementioned values to the grid equation (1), the diffraction angles D according to the appended Table 1 are attained that correspond to the various diffraction orders, said diffraction angles thus corresponding to the cases shown in FIGS. 1 to 3. Table 1 also shows the diffraction efficiencies corresponding to the different diffraction orders m, said efficiencies describing the amount of energy diffracted from the grid G to the order in question. The calculation of the diffraction efficiencies will be described in more detail later in this text. FIGS. 1 to 3 and Table 1 clearly show that when the grid period d is reduced in accordance with the invention, the number of progressive diffraction orders is reduced, in other words the number of observation directions of the effect produced by the grid is reduced.

In the case of a diffraction grid the order m=0 is not considered as an actual diffracted order, and in principle it cannot be used for producing hologram effects either. The reflection of the order m=0 corresponds to the normal surface reflection, i.e. when the grid G is viewed from the direction corresponding to the order m=0, it is possible to see only the image of the light source located in the direction α.

The order m=−1 is the order in which visual hologram effects according to the invention are preferably implemented, because the best diffraction efficiency can be typically attained in this order. In other words, when the incidence angle a of the light source and the viewing angle β of the desired effect in relation to the normal z of the surface of the grid G is fixed, the task is to select such a ratio d/λ according to the grid equation (1) at which the reflection of the design wavelength λ corresponding to the order m=−1 is visible from the desired observing direction β designed for the effect.

Table 1 shows that the ratio d/λ has a quite significant effect on the number of progressive orders as well as on the diffraction angles β characteristic for them. For example, in the section corresponding to FIG. 1 in Table 1 it can be seen that the pattern areas formed by the surface grid G on the surface of the substrate S, i.e. the area on the surface of the substrate S “filled” with the surface grid G is seen as a hologram effect only in the observing directions corresponding to orders m=−1 and m=−2. In the free range of angles between these orders it is not possible to observe any significant diffractive effect, in other words, the surface of the substrate S seems to be substantially similar to the surface of the substrate S without the surface grid G outside said pattern area.

When a transparent plastic film is used as a substrate S, a good transparency through the plastic film is attained from viewing angles deviating from said observing directions m=−1 or m=−2, but a bright hologram effect is observed from viewing angles corresponding to these observing directions.

The efficiency values presented in Table 1 for the actual diffracted orders are typical examples of such efficiencies that can be attained by means of the solution according to the invention in the case of a transparent plastic substrate. In practice, these efficiencies are sufficient for producing a clearly discernible effect.

To attain a sufficient transparency for the visual effect according to the invention, it is an essential aspect that the grid structure G is implemented in such a way that the effect can be discerned only in a relatively narrow range of angles in the vicinity of the observing direction, and when several observing directions (diffraction orders) are used, the angular difference (free range of angles) between the same must also be wide enough. The free ranges of angles between the diffraction orders corresponding to the example situation are shown in Table 1. These are wide enough for producing a transparent range according to the invention between the observing directions.

TABLE 1

| | |
|---|---|
| d/λ = 1.5 | d/λ = 2.1 |

| | Diffraction angle | | | |
|---|---|---|---|---|
| Order m | β | Efficiency | Diffraction angle β | Efficiency |
| +2 | * | — | * | — |
| +1 | * | — | 77.5° | 0.32% |
| 0** | 30.0° | 0.56% | 30.0° | 0.01% |
| −1 | −9.6° | 1.74% | −1.4° | 1.75% |
| −2 | −56.4° | 0.17% | −26.9° | 0.21% |
| −3 | * | — | −68.2° | 1.22% |

d/λ = 1.2

| Order m | Diffraction angle β | Efficiency |
|---|---|---|
| +1 | * | — |
| 0** | −24.68° | 0.48% |
| −1 | −24.68° | 1.66% |
| −2 | * | — |

*progressive order does not exist
**not actual diffracted order

When several observing directions (diffraction orders) are used, the properties of the grid structure G are selected in accordance with the invention preferably in such a manner that a minimum range of angles of 10-15° is formed between the different observing directions, the effect being transparent in said range of angles.

The distribution of energy contained in the light impinging upon the grid G between the various diffraction orders is an essential aspect of the invention to attain a bright, easily observable visual effect. In the following, the ways in which the diffraction efficiencies of various diffraction orders can be affected will be discussed.

According to the invention, the ratio d/λ of the grid period and the wavelength is first selected using the grid equation (1) in such a manner that at least one desired observing direction (diffraction order m and the diffraction angle β corresponding thereto) and that the desired colour, i.e. design wavelength λ is diffracted to this at least one observing direction. Preferably said observing direction is selected such that it corresponds to the diffraction order m=−1. It is obvious that the incidence angle α of light must also be fixed before the value of the grid period at a certain design wavelength λ and at the value of the diffraction order m can be determined.

Thereafter the diffraction efficiency of light reflected in said one or more observing directions i.e. diffraction orders is adjusted. The efficiency of said diffraction order, for example the order m=−1 can be affected by selecting the values of free grid parameters in an appropriate manner.

Because the grid period d was already determined accurately by means of the grid equation (1), it is possible to utilize three free grid parameters for the aforementioned purpose, said grid parameters being in the case of the invention the height h of the grid profile, the filling factor c of the grid and the refractive index n_{S} of the substrate S.

It is possible to influence the refractive index n_{S} of the substrate S by the selection of the substrate material. On top of the substrate S it is also possible to use separate dielectric or metal-based thin films that affect the reflection of light from the substrate. In this context the dielectric thin films refer generally to such light-reflecting film structures that are made of non-metallic materials. Preferably, the coating of the substrate S is made only at the location of the pattern area, wherein the coating does not affect the transparency of the rest of the area.

According to the invention, the value fixed for the filling factor c of the grid is preferably c=d/2, in other words the proportion of the “grid pattern” formed on the surface of the substrate is one half of each grid period d. The filling factor c of the grid affects the so-called degree of modulation of the grid surface. When the filling factor is very small, or correspondingly very large, the degree of modulation of the grid surface is low. The maximum of the degree of modulation of the grid surface and the maximum of the diffraction efficiency are typically attained by using the filling factor of the grid c=d/2.

If for example plastic is selected as the substrate material, the refractive index n_{S} is, in practice, also fixed. Thereafter one of the grid parameters, the height h of the grid can still be selected, said height being optimized in accordance with the invention so that the maximum diffraction efficiency is attained in the desired observing direction, i.e. preferably in the order m=−1

In practice, the optimization of the grid height h must be conducted by means of so-called precise diffraction theories. These theories are discussed for example in chapter 2 (written by Jari Turunen) in “Micro-Optics, Elements, Systems, and Applications” (Taylor & Francis, Cornwall, 1997, editor Hans Peter Herzig).

As to the optimization of the grid height h, it is in this context possible to mention as a rule of thumb that the height h of the grid profile must be in the order of one quarter of the wavelength λ of light in use. Thus, for example for green light λ=550 nm the grid height h=λ/4≈135-140 nm. Considering the possibility that the height h of the grid profile is not optimized at all, the situation can at the worst be such that all light impinging upon the grid G “escapes” to the order m=0, and no signal is substantially detected in the order m=−1. In other words, the optimization of the grid height h is extremely important, and its significance is emphasized especially when poorly reflecting materials, such as transparent plastic, are used.

Table 1 shows the values of diffraction efficiencies calculated by means of the precise diffraction theories according to the aforementioned literary reference and corresponding to FIGS. 1 to 3 in such a manner that the grid height h is optimized by maximizing the diffraction efficiency in the order m=−1. In all the aforementioned cases the grid depth obtained is h=0.26*λ.

Thus, in the invention, the number of the diffraction orders i.e. observing directions is first of all reduced by reducing the grid period d. Thus, the energy reflected from the surface of the grid G is distributed only between the remaining diffraction orders. Furthermore, by optimizing the grid parameters h, c, n_{S}, it is possible to restrict the number of observing directions to only one observing direction that preferably corresponds to the order m=−1. Secondly, in view of the invention it is an essential aspect that a sufficient range of angles remains between the observing directions in which the diffractive effect is not observed, i.e. the effect is substantially transparent.

It should be noticed that even though in the examples above the aim has been to maximize the efficiency in the diffraction order m=−1, the invention is not, however, in any way restricted to these kinds of embodiments. Depending on the embodiment, attempts can be made to maximize the efficiency also in another diffraction order/observing direction, or attempts can be made to implement the relative efficiencies of different diffraction orders/observing directions in a manner deviating from the examples.

According to the invention, the observing direction is selected among directions deviating from the direction of the normal z of the surface, because typically it is desired that the visual effect is transparent when the surface is examined in a direction perpendicular thereto. In other words, when looking perpendicularly through a plastic film or a window made of plastic, the target positioned behind the plastic film or window can be seen without the disturbance of the visual effect. Or when reading a printed document, the text or images printed thereon can be seen when looking perpendicularly towards the surface. When the aforementioned surfaces are examined from the side in a suitable angle, the holographic effect according to the invention can be observed.

Properties of Pattern Areas

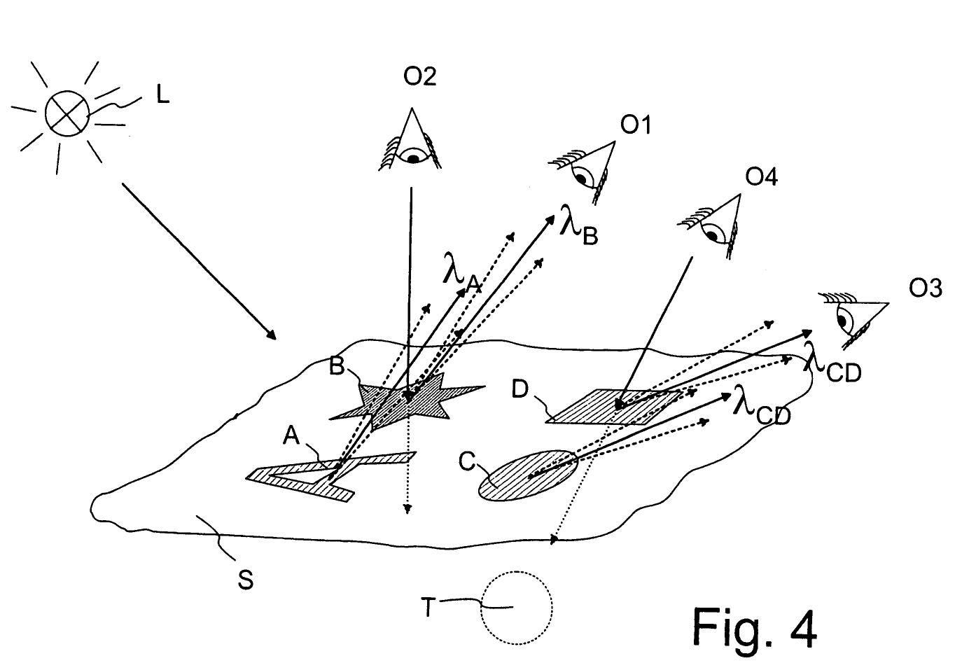

FIG. 4 shows by way of example and in principle some pattern areas A to D formed on the substrate S. In the situation of FIG. 4, the material of the substrate is substantially transparent plastic film that makes it possible to examine a target T placed behind a plastic film through said plastic film.

Each of the pattern areas A to D is formed on the surface of the substrate S by “filling” an area corresponding to each pattern with a grid structure G. In FIG. 4 the surface grids are illustrated by means of rulings on the pattern areas. For anyone skilled in the art it is, of course, obvious that the density of the rulings shown in FIG. 4 does not in any way correspond to the grid periods used in actual surface grids.

In FIG. 4 the grid structures of the pattern area A and B are implemented in such a manner that they share the same observing direction O1. In the observing direction O1, the pattern area A is implemented to reflect the design wavelength λ_{A} diffractively. In the range of angles formed on both sides of the observing direction O1 (arrows marked with broken lines on both sides of the arrow illustrating the design wavelength λ_{A}) the visual effect (letter pattern) corresponding to the pattern area A can be detected in different colours of the spectrum, depending on the spectrum emitted by the light source L. The pattern area B, in turn, is arranged to reflect the design wavelength λ_{B} in the observing direction O1. In other words, when examined from the observing direction O1, the visual effects (letter and star patter) corresponding to the pattern areas A and B are detected in different colours.

When the surface of the substrate S is examined from the viewing direction O2, the visual effects corresponding to the pattern areas A and B are substantially transparent in accordance with the invention. Thus, the viewer can see the target T positioned behind the substrate S (plastic film) through the pattern areas A and B.

For the pattern areas C and D, substantially the same observation direction O3 is designed in such a manner that both pattern areas can be seen in the same colour when examined from said direction, i.e. both pattern areas C, D share the same design wavelength λ_{CD}. When examined for example from the observing direction O4, the pattern areas C and D, as well as A and B are substantially transparent.

In the example of FIG. 4, the pattern areas A to D are designed in such a manner that they both have substantially one observing direction, i.e. the hologram effect can be detected from directions corresponding to only one diffraction order.

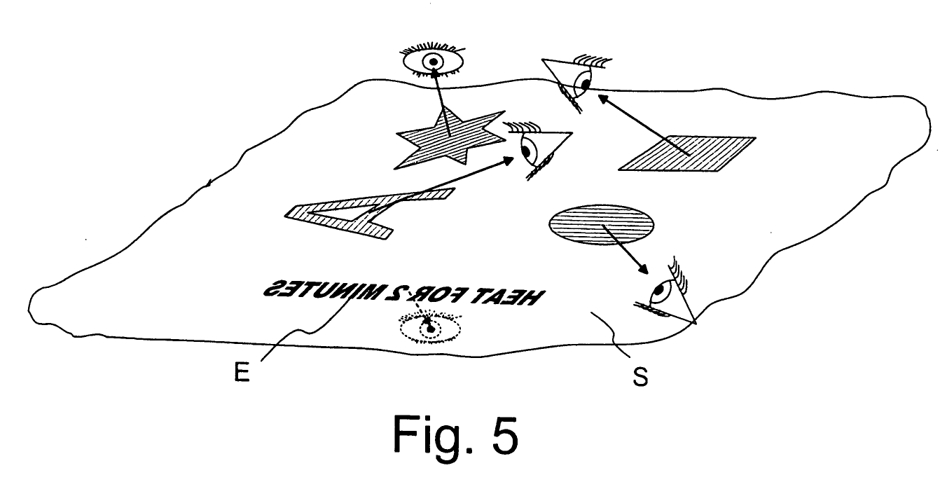

The number, surface area and shape of the pattern areas as well as their observing directions and characteristic wavelengths can be freely selected according to the embodiment in question. FIG. 5 shows by way of example a situation in which the pattern areas implemented on a substrate S have observing directions differing from each other. The text “HEAT FOR TWO MINUTES” that is formed of adjacent pattern areas is in this example arranged to be observed from the opposite side of the substrate in relation to other pattern areas.

To produce a large area with a uniform visual effect, it is instead of one large pattern area also possible to use several similar, but smaller-sized pattern areas arranged next to each other. By producing a larger area as a matrix of several smaller pattern areas, it is possible to ease the demands set for example for the manufacturing technique.

Examples of Substrate Materials and Grid Profiles

The grid structure G according to the invention and the visual effects produced by means of the same can be implemented on a number of different substrate materials.

Preferably, the grid structures G are produced as surface grid structures for example by using the embossing technique directly on a transparent, plastic-like material, such as a plastic film. Thus, a plastic film suitable for packaging material, such as wrapping or the like is attained, said material being transparent both for the part of the substrate material and the visual effects in the way referred to in this application.

Transparent, so-called hologram lacquer or the like is also suitable as a substrate material, and it can be used for coating either transparent or non-transparent base material. Advantages of the use of the hologram lacquer include the fact that the lacquer layer can be utilized to smooth out the irregularities on the base material. The use of the lacquer may also reduce the wearing of the expensive printing plate necessary in embossing.

The grid structures G according to the invention can also be produced by means of embossing directly on paper or paperboard or on corresponding non-transparent materials that are used for example in different printed products. Thus, the pattern printed on the substrate or in another way, for example by dyeing thereon produced pattern can be clearly seen “through” the visual effect according to the invention from those viewing directions that deviate from the observing direction designed for the effect.

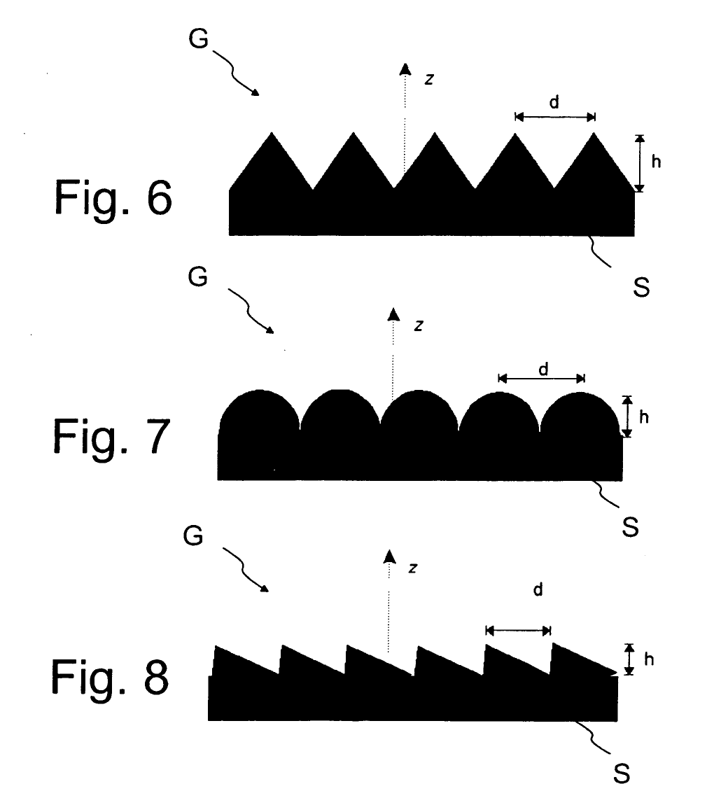

The holographic effects according to the invention can be implemented by means of periodic or non-periodic grid profiles of several different types. FIGS. 6 to 8 present by way of example some alternative grid profiles for the binary grid profiles shown in FIGS. 1 to 3. For each embodiment it is possible to select a grid profile best suitable for the purpose for example on the basis of the manufacturing method of the grid. When the grid structures are manufactured as surface grids by means of embossing, the substantially sinusoidal grid profile shown in FIG. 7 by way of example is advantageous, because the shape of the grid profile can be precisely reproduced by embossing, i.e. it is reproducible by pressing. FIG. 8 shows a so-called blazed-type grid profile known as such from optics, said grid profile providing more degrees of freedom when affecting the diffraction efficiencies of the diffraction orders.

It is also possible that in the grid structure according to the invention one grid period d can contain more than one grid line, and said grid lines can also deviate from each other in width.

As for the manufacturing techniques of grid structures, the invention is not restricted solely to the use of embossing techniques, but in principle, the grid structures can also be manufactured by means of other techniques suitable for the purpose.

Furthermore, it is possible that the grid structure according to the invention is protected by means of a transparent protective layer formed on top of the same to protect the grid structure from fouling and wearing. Suitable protection methods include for example varnishing or a corresponding action. Deviating from the surface grid structure, the grid structure according to the invention can also be implemented either partially or entirely as a buried grid structure, which can be made for example by laminating. The grid structure according to the invention can be formed for example from grid lines of metal produced on top of a plastic film. Such a grid structure can also be buried underneath one or several plastic films, if necessary. The grid lines in a grid structure can, in principle, be produced in any way evident for anyone skilled in the art.

The Use of Visual Effects in Products

In principle, the invention is suitable to be used for all such purposes in which holograms of prior art are used. These uses include for example prevention of forgeries in various official documents, means of payment, packages of audio recordings and software products, other printed products, adhesive labels, or the like.

Most advantageously the invention is, however, suitable to be used for increasing the attractiveness of various products in markets of strong competition. Because the grid structures according to the invention can be mass-produced for example by means of embossing on a number of different and advantageous substrate materials, by means of the invention it is possible to manufacture for example packaging material, such as plastic film suitable as a wrapping material, containing bright and easily observable holograms that do not, however, prevent seeing the actual product through the packaging material.

For example product packages placed on a shelf or on a display in a store become attractive for the customer when the colour of the hologram effects produced on the packages changes according to the viewing direction. Because the effects according to the invention are substantially transparent when viewed from certain viewing directions, they “flash” into view when the viewing direction changes, thus catching the attention of the customer efficiently. By designing the observing directions and the design wavelengths visible thereto in a suitable manner, it is possible to imitate the colours normally associated to the trademarks.

It is also possible to implement different kinds of instructions, product descriptions or other product information in the packages, which information can be seen only from specific viewing directions.

According to the invention the effect becomes distinct and attractive when the diffraction order (observing directions) from which the effect can be seen are limited. By producing several different pattern areas on the same substrate, so that the pattern areas have to some extent different observing directions, it is possible to ensure that one of said pattern areas is always visible. As there are typically always several product packages positioned next to each other, and their mutual position in relation to the viewer thus always changes to some extent, the effect according to the invention can always be seen at some point.

By means of the invention, it is possible to produce an easily observable visual effect, but still a transparent package. This is especially important in the case of different food products, because the consumer also wishes to be sure of the freshness of the food product, such as vegetables, meat or fish he or she has bought visually as well by examining the product through the package.

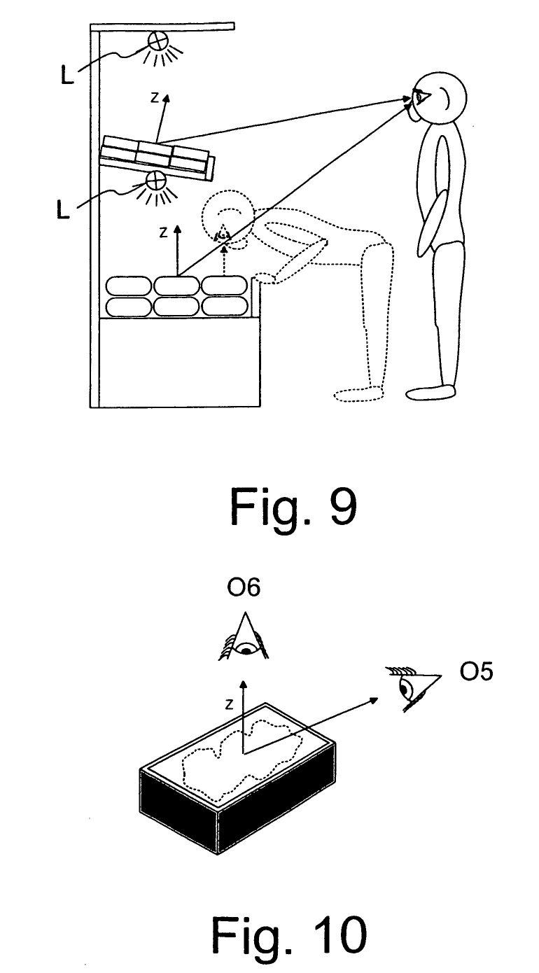

When the observing directions of the effects produced on the packaging material are selected, it is also possible to take into account the fact how the product packed in said packaging material is displayed in a store when designing the effects/surface grids. This situation is illustrated in the appended FIGS. 9 and 10.

For example a package of meat can be placed on a shelf in a store in such a manner that the transparent plastic film containing the hologram effects and functioning as the “cover” of the package or a “window” in the cover is positioned in a substantially horizontal position and the lighting impinges upon the plastic film substantially from the direction of the normal z of its surface, i.e. from above.

The surface grids producing the hologram effect can now be optimized in such a manner that they create for example an observing direction of 45° in relation to the normal z of the plastic film, wherein the effects are visible to the customer walking past the shelf (In FIG. 9, the figure drawn in solid lines, and in FIG. 10 the viewing direction O5). If the customer comes closer to the shelf and “sticks” his or her head closer between the shelf, looking at the product substantially in the direction of the normal of the cover of the package (plastic film) (in FIG. 9 the figure drawn in broken lines, viewing direction O6), he or she will not distinguish the holographic effect in this direction, but sees the product in the package through the transparent cover.

If the customer takes the package in his or her hand and examines it in the direction of the normal of the package, the hologram effects will not be disturbingly visible at this situation either. In this example situation, the holographic effect can consist for example of the name and logo of the producer of the meat product, which can be implemented so that their design wavelengths correspond to the correct colours and so that they can both be seen from the same observing direction.

If necessary, the observing directions used in packages can be designed so that it is taken into account on which shelf and in which position the packages are displayed. In FIG. 9, it is possible to utilize different observing directions in the packages on the top shelf and on the lower level, taking into account that the consumer looks at the packages from different angles from the aisle.

Packaging material containing hologram effects does not necessarily have to be used as planar “window” in a product package, but the package material equipped with visual effects according to the invention can also be used as if it would be a wrapping paper. This also ensures that when the viewing direction becomes different in different parts of the packaging material, some pattern area is always visible.

The impact of the visual effects according to the invention can be improved in practice by designing them especially for certain lighting conditions. When designing the grid structures, it is possible to take into account both the direction of the lighting as well as the wavelength distribution emitted by the light source L. The grid structures according to the invention can also be manufactured such that they can be observed by the human eye only in a certain kind of lighting, wherein they can be used as invisible security symbols.

The hologram effects according to the invention are a very efficient way to improve the image value of the product, because a hologram is typically associated with quality products. The present invention gives for the first time a genuine possibility to attach hologram effects also in products sold as mass products without significantly increasing the production costs of said products.

It is, of course, obvious that the invention is not limited solely to the embodiments presented in the previous examples, but the invention is to be interpreted only according to the limitations set by the appended claims.

1-25. (canceled)

26. A micro-optical grid structure produced on a substrate, said grid structure being produced as a surface structure, a structure protected with a protective layer, or as an entirely or partially buried structure, which grid structure is arranged to produce for a viewer a holographic or a corresponding visual effect based on the diffraction of light by directing the light diffracted from said grid structure and corresponding to a visible wavelength substantially to one or more diffraction orders, each single diffraction order corresponding to a certain observing direction of the visual effect observable at said visible wavelength, and said grid structure being arranged to leave a free range of angles such that said grid structure being examined from directions corresponding to said range of angles does not produce for the viewer a clearly observable effect based on diffraction, wherein said grid structure is embossed, the ratio of the grid period of said grid structure to said visible wavelength being smaller than 5, and said grid structure comprising non-metallic material only.

27. The grid structure according to claim 26, wherein said grid structure is arranged to direct the light diffracted therefrom substantially in only one diffraction order, i.e. substantially in only one observing direction that preferably corresponds to the diffraction order m=−1.

28. The grid structure according to claim 26, wherein said free range of angles is at least 10°.

29. The grid structure according to claim 26, wherein said grid structure is produced on a substantially transparent substrate.

30. The grid structure according to claim 29, wherein said substrate is made of plastic or lacquer, preferably of a plastic film or a lacquer layer.

31. The grid structure according to claim 26, wherein said grid structure is produced on paper, paperboard or other corresponding substrate.

32. The grid structure according to claim 26, wherein the substrate of said grid structure comprises one or several dielectric thin film coatings on the entire surface area of the substrate or only at the locations corresponding to said grid structure.

33. A method for producing a micro-optical grid structure on a substrate, said grid structure being produced as a surface structure, a structure protected with a protective layer, or as an entirely or partially buried structure, which grid structure is adapted to produce for a viewer a holographic or corresponding visual effect based on the diffraction of light, said method comprising at least selecting the shape of the grid profile of said grid structure together with the grid parameters such that the light diffracted from said grid structure and corresponding to a visible wavelength is directed substantially to one or more diffraction orders, each single diffraction order corresponding to a certain observing direction of the visual effect observed at said visible wavelength, and a free range of angles remaining such that said grid structure being examined from directions corresponding to said range of angles does not produce for the viewer a clearly observable effect based on diffraction, wherein said method further comprises embossing said grid structure such that the ratio of the grid period of said grid structure to said visible wavelength is smaller than 5, said grid structure comprising non-metallic material only.

34. The method according to claim 33, wherein the value of the incidence angle of light impinging upon said grid structure at said visible wavelength is fixed, and the ratio of said grid period (d) and said visible wavelength is selected such that one desired observing direction is attained, said observing direction being preferably selected so that it corresponds to the diffraction order m=−1, wherein the desired design wavelength is diffracted to said one observing direction.

35. The method according to claim 33, wherein the parameters of said grid structure are selected in such a manner that the free range of angles is at least 10°.

36. The method according to claim 33, wherein the diffraction efficiency to said one or more observing directions is affected by the selection of the parameters of said grid structure.

37. The method according to claim 33, wherein the width of said grid profile is selected to be substantially half of said grid period.

38. The method according to claim 33, wherein substantially one quarter of the value of said visible wavelength is selected as the value of the height of said grid profile.

39. The method according to claim 33, wherein a substantially transparent material, preferably plastic, lacquer or the like is selected as the substrate of the grid structure.

40. A product comprising at least one pattern area formed of a micro-optical grid structure produced on a substrate, said grid structure being produced as a surface structure, a structure protected with a protective layer, or as an entirely or partially buried structure, which grid structure is arranged to produce for a viewer a holographic or a corresponding visual effect based on the diffraction of light by directing the light diffracted from said grid structure and corresponding to a visible wavelength substantially to one or more diffraction orders, each single diffraction order corresponding to a certain observing direction of the visual effect observable at said visible wavelength, and said grid structure being arranged to leave a free range of angles such that said grid structure being examined from directions corresponding to said range of angles does not produce for the viewer a clearly observable effect based on diffraction, wherein said grid structure is embossed, the ratio of the grid period of said grid structure to said visible wavelength being smaller than 5, and said grid structure comprising non-metallic material only.

41. The product according to claim 40, wherein said product is made of plastic, preferably of a plastic film.

42. The product according to claim 40, wherein said product is made of paper, paperboard or a corresponding material.

43. The product according to claim 40, wherein said product is of packing material.

44. The product according to claim 40, wherein said product is a printed product.

45. The product according to claim 40, wherein said product is made of substantially transparent material.

46. The product according to claim 40, wherein the basic material of said product at the same time acts as the substrate of the grid structure.

47. The product according to claim 40, wherein when the product comprises several pattern areas, at least two of said pattern areas have different observing directions and/or design wavelengths.

48. The product according to claim 40, wherein said at least one pattern area forms as an effect a trademark, a logo, a product description or the like.

49. The product according to claim 40, wherein said at least one pattern area forms as an effect characters or text.

50. The product according to claim 40, wherein said product comprises several adjacent pattern areas that are similar to each other and that are arranged to form together a larger area with a substantially uniform visual effect.
